(19) United States
(12) Patent Application Publication
(10) Pub. No.: US 2004/0003696 A1
(43) Pub. Date: Jan. 8, 2004

(54) Sliding miter fence

(76) Inventor: Richard Ray Radda, Williams, OR (US)

Correspondence Address: Richard Ray Radda, Glenlyn Drive, P.O. Box 59-105, Williams, OR, 97544, US

(21) Appl. No.: 10/172,041

(22) Filed: Jun. 13, 2002

(51) Int. Cl. B26D 7/06; B23D 25/00; B26D 5/08

(52) U.S. Cl. 83/437.1; 83/581

(57) ABSTRACT

1,2,3,7, of the diagram are not parts of the sliding miter fence but are shown to help with the understanding of the sliding miter fence. Table of the radial arm saw (1) is necessary for the insertion of the sacraficial wood track (4) which is clamped into place between the table top and a backing strip that goes in back of the wood track and all are clamped into place, radial arm saw (2) used with the sliding miter fence (6),fixed sacrificial wood track (4) extending on either side of the maximum angle of the saw blade (3) by 2 inches and butts up to the aluminum fixed track (5), aluminum fixed track (5) made of square tubing milled down the length of one side only to fit inside the sliding fence (6) and secure the fix track (5) to the table top (1) with flat head wood screws or flat head machine bolts, the sliding fence (6) fitting over the fixed track (5) allows adjustments for measurment of work and after adjustments the sliding fence (6) is clamped into place to keep the integrity of the measurment.

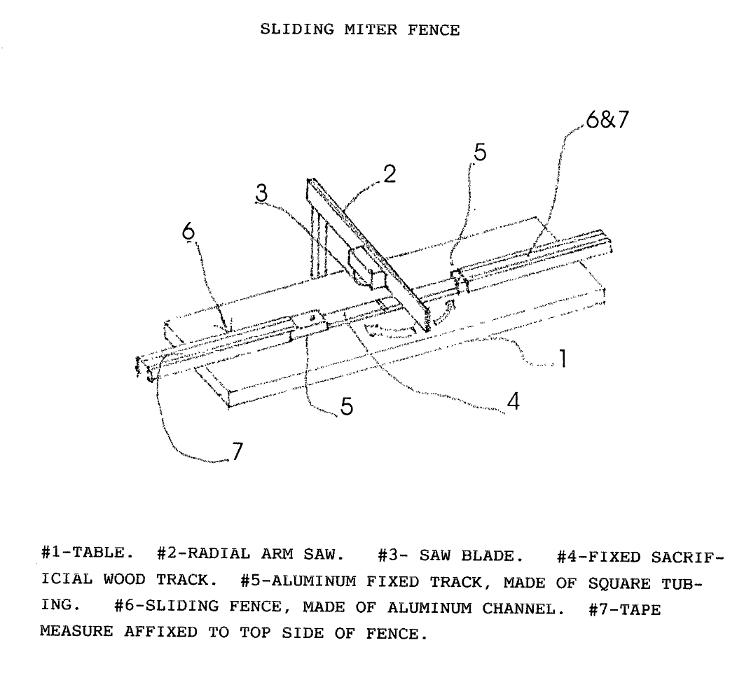

The measuring tape (7) if used, goes on top of the sliding miter fence (6) and simplifies measuring. #1-table #2-radial arm saw. #3-saw blade. #4-fixedsacrificial wood track. #5-aluminum fixed track,made of squaretubing. #6-sliding fence, made of aluminum channel. #7-tapemeasure affixed to top of fence.

The sliding miter fence came about after many years of working with a fixed wooden fence, that was affixed to the extension table of my radial arm saw table, witch also had a measuring tape affixed to the top of the fixed wooden fence, that ran along the front of the blad, the fence was 11 ft. in length and extended past the blade by 2 ft. The measuring tape was affixed to the left and next to the blade. My main working side was to the left of the blade.

My problem was, if I wanted to make angle cuts to the left of the blade I would be cutting into my tape so all of my angle cuts would have to be made to the right of the blade (like intricat moldings, etc). Another problem would be splintering out at the ends when the molding was faceing in. That would have angle cuts at both ends, the desired cut would be the left or right side of the blade, the side that didn't have the measuring tape a fixed to the fence would be the desired side to cut. But my problem was that I only had 9 ft. to the left side to work with and only 2 ft. to the right side. This was my setup. So I solved my problems by developing the sliding miter fence. The purpose for the tape, on top of the fixed fence, was to allow me to use a sliding miter stop that would lock into place for any length of cut. The miter stop is not a part. of my invention.

The sliding miter fence consist of these parts, (1) a sacraficil wood fence, (2) a fixed aluminum square tubing witch will be the fixed track. (3) Aluminum channel. Which is the slider on the fixed track

1-sacraficil wood fence—this piece is clamped into the table of radial arm saw just in front of the saw blade and exstends 2 inches beyond the maximum angle cut on both sides of the blade which can be up to sixty degrees, this is done for both ends of the wood strip, the wood strip is also the same width as the fixed track.

2-square tubing—the square tubing is milled down along its length on one side only, so that it will fit inside the the channel, the square tubing is the fixed track that is fastened to the extension table of the radial arm saw, after it is butted up to the wood strip and aligned to the wood strip by means of a straight edge, this is to allow the channel to slide over both the square tubing and the wood strip; the track is then fastend down, onto the extenion table of the radial arm saw by means of flat head wood screws or flat head carrage bolts. The reason for these steps is for a firm backing for the wood being worked.

3-aluminum channel. This is the sliding part that makes up sliding fence. This unit will also have an a fixed measuring tape on the top side of the channel, the tape is of the customer's choice, the channel, like the track, when put together can be of any length, but of equal length. The track setup can be used either on the left, right, or both sides of the blade.

### BRIEF SUMMARY OF THE INVENTION

The idea of this product is to make it easier for the saw operator to make all of his angle cuts to the left or right of the blade. The setup will be discussed in the detailed description of the invention. The addid benefit that I also achieved, was that when making angle cuts on molding and trim by using both sides of the saw blade and keeping the finished side towards the operator that there would be no splintering out of the ends, as I would always have with the old fenc, because I always would have to switch ends for each cut whitch would leave me with splintered out ends. One other benefit of my invention was I didnot have to spend eighteen to two thousand dollars to buy a center pivot radial arm saw.

4-DETAILED DESCRIPTION OF THE INVENTION

The operation of the unit is this. To make angle cuts to the left or right you first slide the fence back away from the saw blade, if cutting to the left or right, then swing the blade to the desired angle locking in place, then sliding the fence up to the blade, you bring the blade out so that the teeth of the blade protrude just past the channel, you then set your miter stop, (stop of their choice) over the measuring tape, lets say to 6″, then clamp the stop in place. Measure 6″ from the teeth along the side of the fince back to the sliding miter stop untill you have 6″ distence between the blade and miter stop when you have it set, clamping, the fence, with a clamping system of their choice, to the table. Next you bring the opposit side channel up to the other side of the saw blade just next to the blade and clampind it, also the clampin system of their choice. The system set up is used for both left and right of the blade. You are now ready to cut.

My system is designed to set up on either side. measuring tapes are made to measure from right to left or left to right

1. The only claim that I have for my invention is the sliding fence, plus there are no cross references to my invention.
